(19) United States
(12) Patent Application Publication
(10) Pub. No.: US 2021/0339957 A1
(43) Pub. Date: Nov. 4, 2021

(54) LOGISTICS WAREHOUSING SYSTEM

(71) Applicant: ALLY LOGISTIC PROPERTY CO., LTD., Taipei (TW)

(72) Inventors: Chien-Tai Chang, TAIPEI (TW); Ying-Chien Jang, TAIPEI (TW); I-An Wu, TAIPEI (TW); Chun-Pi Chang, TAIPEI (TW)

(21) Appl. No.: 16/991,711

(22) Filed: Aug. 12, 2020

(30) Foreign Application Priority Data
Apr. 30, 2020 (TW) 109114574

(51) Int. Cl. B65G 1/137; B65G 47/42; B65G 15/02

(52) U.S. Cl. CPC B65G 1/1378; B65G 1/1371; B65G 2812/02217; B65G 15/02; B65G 2203/0208; B65G 47/42

(57) ABSTRACT

A logistics warehousing system includes a conveying device, a plurality of delivery containers, and at least one packing station. The conveying device includes an circular conveyor surrounding a central area. The circular conveyor circulates cyclically relative to the central area. The plurality of delivery containers include at least one first delivery container and at least one second delivery container different from the first delivery container. The plurality of delivery containers are placed on the circular conveyor and circulate along a circular track around the central area cyclically as the circular conveyor circulates. One of the packing stations receives one of the plurality of delivery containers from the conveying device.

### FIELD OF THE INVENTION

The present invention relates to a warehousing system, and more particularly to a logistics warehousing system.

### BACKGROUND OF THE INVENTION

The logistics of goods has always been an important issue in modern society. With the flourishing development of network applications, online shopping is almost inseparable to human life. Various types of online shopping platforms, models and logistics distribution are emerging.

In the field of logistics operations, order processing is a major issue in sales. Picking up and tally operations often occupy the highest proportions of work and cost in logistics operations. Among them, the processing of packing or boxing goods for each order is one of the core tasks of logistics. It is necessary to choose the appropriate packing for orders of various different contents, which not only consumes a lot of operation cost, but also poses a great challenge to the use and operation of warehousing space. Therefore, how to optimize the logistics packing operation to improve efficiency is an urgent problem to be solved.

### SUMMARY OF THE INVENTION

The present invention provides a logistics warehousing system capable of improving an efficiency of the logistics warehousing system and effectively using the warehousing space.

Other objects and advantages of the present invention can be further understood from the technical features disclosed by the present invention.

The logistics warehousing system of the present invention includes a conveying device, a plurality of delivery containers, and at least one packing station. The conveying device includes a circular conveyor surrounding a central area. The circular conveyor circulates cyclically relative to the central area. The delivery containers include at least one first delivery container and at least one second delivery container different from the first delivery container. The delivery containers are placed on the circular conveyor and circulate along a circular track around the center area cyclically as the circular conveyor circulates. One of the at least one packing stations receives one of the plurality of delivery containers from the conveying device.

In one embodiment of the present invention, the above-mentioned logistics warehousing system further includes a control device, the control device selects one delivery container with a specific size from the conveying device according to an order data, wherein the packing station receives the delivery container which is selected from the conveying device.

In one embodiment of the present invention, the above-mentioned logistics warehousing system further includes a control device, a receiving device, a delivery device, and a recovery device. The receiving device is disposed to place and move at least one collecting container. The control device selects one of the at least one collecting container from the receiving device according to an order data, at least one goods is placed in the collecting container which is selected, and the control device selects one of the plurality of delivery containers from the conveying device according to the order data. Wherein the packing station receives the delivery container which is selected from the conveying device, and after the packing station places the at least one goods into the delivery container, the packing station moves the delivery container onto the delivery device and moves the collecting container onto the recovery device.

In one embodiment of the present invention, each of the at least one packing station includes a picking device, one of the picking devices receives the delivery container selected by the control device, and one of the picking devices places at least one goods into an accommodating space of the delivery container.

In one embodiment of the present invention, the above-mentioned logistics warehousing system further includes a transport device, the transport device moves the delivery container selected by the control device to one of the at least one packing station according to the order data, wherein each of the packing stations includes a picking device, the picking device is disposed to place at least one goods into an accommodating space of the delivery container which is received by the picking device.

In one embodiment of the present invention, the above-mentioned logistics warehousing system further includes a receiving device disposed to place and move at least one collecting container, the control device selects one of the at least one collecting container from the receiving device according to the order data, and the at least one goods is placed in the collecting container which is selected.

In one embodiment of the present invention, the above-mentioned logistics warehousing system further includes a recovery device, and after the picking device places the at least one goods into the delivery container, the picking device moves the collecting container onto the recovery device.

In one embodiment of the present invention, the above-mentioned logistics warehousing system further includes a delivery device, and the picking device moves the delivery container placed with the at least one goods onto the delivery device.

In one embodiment of the present invention, the above-mentioned logistics warehousing system further includes a container supply device, the container supply device includes a box opener that converts the delivery container from a storage state to an accommodating state; and a temporary storage area connected to the box opener, the temporary storage area includes a plurality of conveyor belts respectively corresponding to the first delivery container and the second delivery container, and each of the plurality of conveyor belt has a receiving end connected to the box opener and an output end connected to the circular conveyor.

The logistics warehousing system of the present invention includes a conveying device, at least one packing station, a receiving device, a delivery device, and a recovery device. The conveying device includes an circular conveyor surrounding a central area, and the circular conveyor circulates cyclically relative to the central area. A plurality of delivery containers include at least one first delivery container and at least one second delivery container different from the first delivery container. The plurality of delivery containers are placed on the circular conveyor and circulate along a circular track around the center area cyclically as the circular conveyor circulating. One of the packing stations receives one of the plurality of delivery containers from the conveying device. The receiving device is disposed to place and move at least one collecting container, and at least one goods is placed in the collecting container. The packing station receives one of the at least one collecting container from the receiving device, after the packing station places the at least one goods into the delivery container which is received, the packing station moves the delivery container onto the delivery device and moves the collecting container onto the recovery device.

Based on the above, the logistics warehousing system provided by the present invention allows the packing stations to receive the correct delivery container from the conveying device effectively, accurately and quickly by disposing the conveying device with the circular conveyor, thereby capable of greatly improving the efficiency of the logistics warehousing system and effectively using the warehousing space.

In order to make the above features and advantages of the present invention more obvious and understandable, the embodiments are described in detail below with reference to the accompanying drawings.

### BRIEF DESCRIPTION OF THE DRAWINGS

FIG. 1 is a schematic diagram of a logistics warehousing system according to one embodiment of the present invention;

FIG. 2 is a partial schematic diagram of the logistics warehousing system according to one embodiment of the present invention;

FIG. 3 is a schematic diagram of the logistics warehousing system according to one embodiment of the present invention;

FIG. 4 is a functional block diagram of the logistics warehousing system according to one embodiment of the present invention;

FIG. 5 is a schematic diagram of the logistics warehousing system according to another embodiment of the present invention;

FIG. 6 is a functional block diagram of the logistics warehousing system according to another embodiment of the present invention;

FIG. 7 is a schematic diagram of the logistics warehousing system according to yet another embodiment of the present invention;

FIG. 8 is a functional block diagram of the logistics warehousing system according to yet another embodiment of the present invention; and

FIG. 9 is a schematic diagram of a container supply device of the logistics warehousing system according to one embodiment of the present invention.

### DETAILED DESCRIPTION OF THE PREFERRED EMBODIMENTS

The foregoing and other technical contents, features and efficacies of the present invention will be clearly presented in the following detailed description with reference to the preferred embodiments of the accompanying drawings. The directional terms mentioned in the following embodiments, for example: “above”, “below”, “left”, “right”, “front”, “rear”, etc., are merely directions referring in the accompanying drawings. Therefore, the directional terms are used to illustrate rather than limit the present invention.

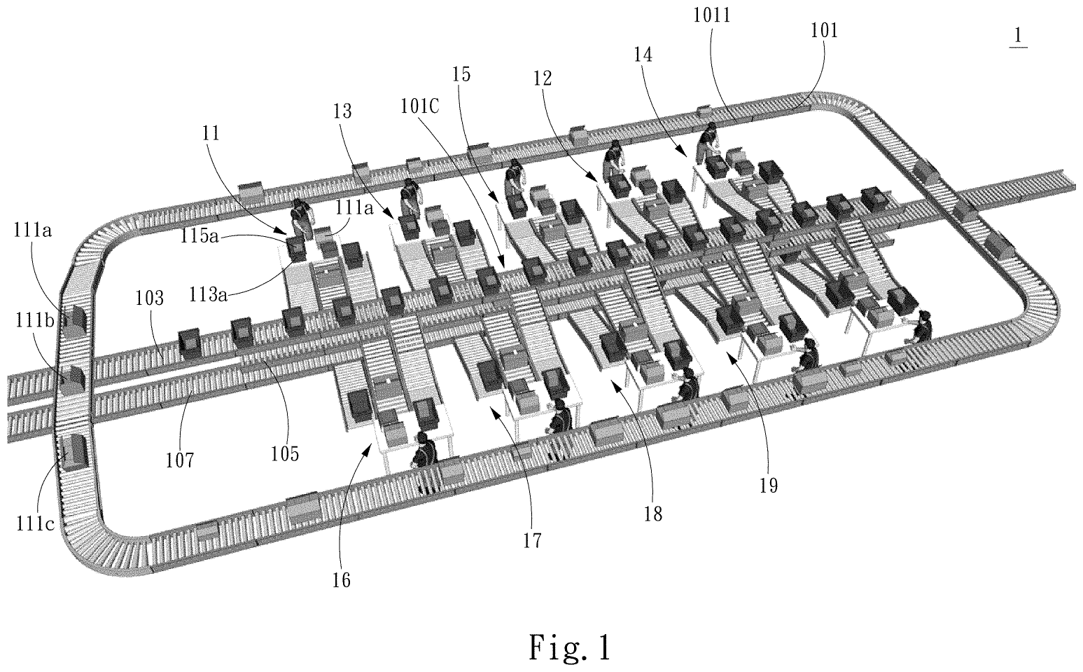

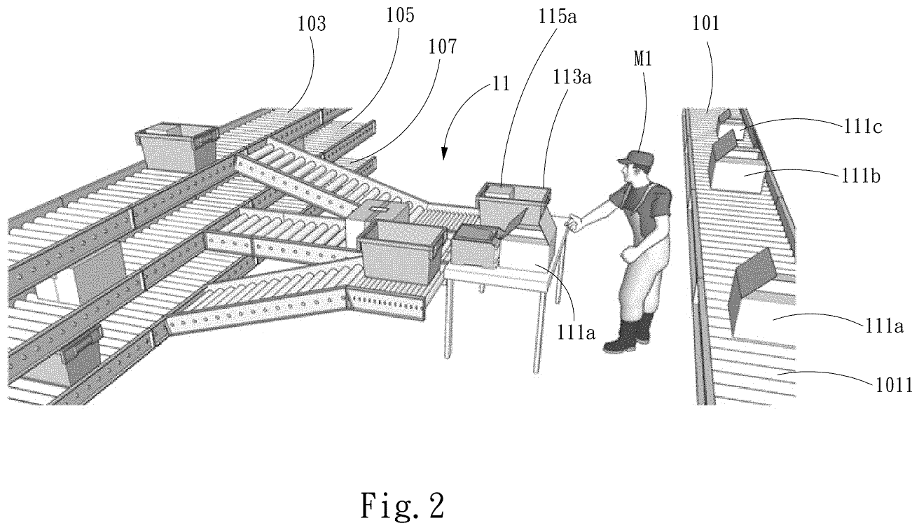

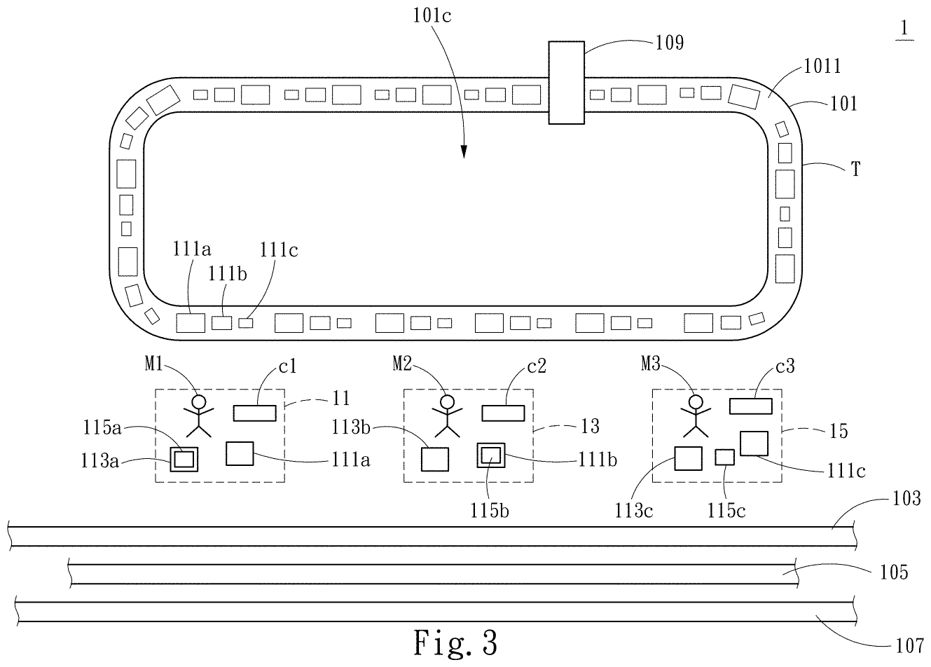

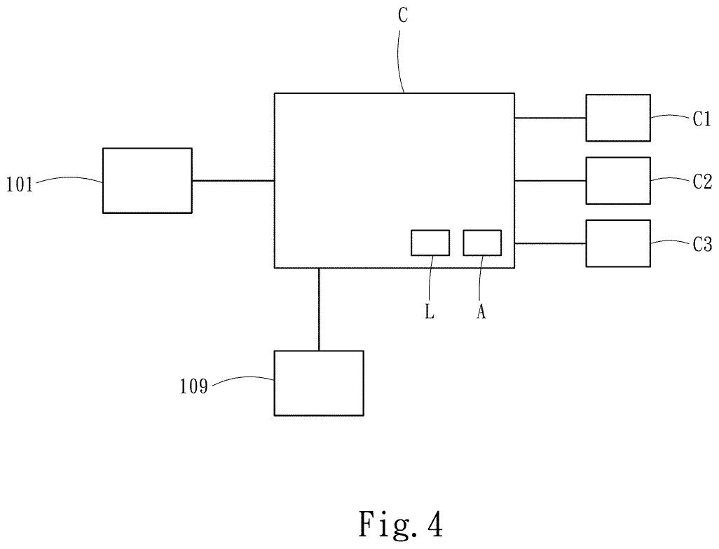

Please refer to FIGS. 1 and 2. FIG. 1 is a schematic diagram of a logistics warehousing system 1 according to one embodiment of the present invention. FIG. 2 is a partial schematic diagram of the logistics warehousing system 1 shown in FIG. 1. The logistics warehousing system 1 includes a conveying device 101, a plurality of delivery containers 111a, 111b, 111c, and a plurality of packing stations 11, 12, 13, 14, 15, 16, 17, 18, 19. The conveying device 101 includes a circular conveyor 1011. The plurality of delivery containers 111a, 111b, 111c are placed on the circular conveyor 1011 to circulate cyclically, so that the packing stations 11, 12, 13, 14, 15, 16, 17, 18, 19 are capable of receiving the delivery container which is correct from the conveying device 101 effectively, accurately and quickly, such that an efficiency of the logistics warehousing system 1 and effectively using the warehousing space are greatly improved. FIG. 2 is a partial schematic diagram of the packing station 11 in FIG. 1. The specific operation details will be explained in detail in FIGS. 3 and 4.

Please refer to FIG. 3, FIG. 3 is a schematic diagram of the logistics warehousing system 1 according to one embodiment of the present invention. The logistics warehousing system 1 of the present invention includes at least one packing station, and for convenience of description, three packing stations 11, 13, 15 are taken as an example in FIG. 3. The logistics warehousing system 1 includes the conveying device 101, the plurality of delivery containers 111a, 111b, 111c, and the packing stations 11, 13, 15. The conveying device 101 includes the circular conveyor 1011 surrounding a central area 101c. The circular conveyor 1011 circulates cyclically relative to the central area 101c. The plurality of delivery containers 111a, 111b, 111c include a first delivery container 111a and a second delivery container 111b different from the first delivery container 111a. The plurality of delivery containers 111a, 111b, 111c are placed on the circular conveyor 1011 and circulated along a circular track T around the central area 101c cyclically as the circular conveyor 1011 circulating. One of the packing stations 11, 13, 15 is capable of receiving one of the plurality of delivery containers 111a, 111b, 111c from the conveying device 101, so that the packing stations 11, 13, 15 are capable of receiving the appropriate delivery container from the conveying device 101 effectively, accurately and quickly.

In detail, the plurality of delivery containers 111a, 111b, 111c include the first delivery container 111a and the second delivery container 111b different from the first delivery container 111a, therefore, the plurality of delivery containers 111a, 111b, 111c placed on the conveying device 101 can be the same or different. For example, the plurality of delivery containers 111a, 111b, 111c can have the same or different sizes or accommodating spaces.

Through disposing the conveying device 101, the same or different delivery containers 111a, 111b, 111c are placed on the conveying device 101. The plurality of delivery containers 111a, 111b, 111c are capable of circulating cyclically along with movement of the circular conveyor 1011, so that the plurality of delivery containers 111a, 111b, 111c are capable of moving cyclically to the sides of the packing stations 11, 13, 15, thereby the packing stations 11, 13, 15 are capable of receiving the plurality of delivery containers 111a, 111b, 111c from the conveying device 101 efficiently and quickly. By enabling the packing stations 11, 13, 15 to easily obtain the delivery containers 111a, 111b, 111c which are required (such as with specific sizes or accommodating space, etc.), the efficiency of the logistics warehousing system 1 and effectively using the warehousing space are greatly improved. Receiving the delivery containers 111a, 111b, 111c from the conveying device 101 by the packing stations 11, 13, 15 is achieved by, for example, manual, using robotic arm, and/or automated guided vehicle (AGV), and the present invention is not limited thereto.

In addition, the delivery containers 111a, 111b, 111c can be, for example, boxes or packaging bags for loading goods, but the present invention is not limited thereto. In this embodiment, the logistics warehousing system 1 includes the plurality of delivery containers with the same size or different size s. FIG. 3 only indicates the delivery containers 111a, 111b, 111c as an example.

A shape of the circular conveyor 1011 and the circular track T shown in FIGS. 1 and 3 is only one possible way of implementation, and is not intended to limit the present invention. The circular conveyor 1011 of the present invention which is capable of cyclically moving along a circular track is within the scope of the present invention. In this embodiment, cyclical movement of the circular conveyor 1011 is realized by a mechanism such as motor and/or gears (not shown in the figures), and the details are not repeated here.

In this embodiment, the packing stations 11, 13, 15 manually receiving the plurality of delivery containers 111a, 111b, 111c from the conveying device 101 is used as an example. The packing stations 11, 13, 15 are disposed with personnel M1, M2, M3 respectively. The personnel M1, M2, M3 are capable of conveniently and quickly obtaining the delivery containers 111a, 111b, 111c which are required from the conveying device 101. Please refer to FIG. 4 as well, which is a functional block diagram of the logistics warehousing system 1 shown in FIG. 3. In this embodiment, the logistics warehousing system 1 further includes a control device C. The control device C selects one of the plurality of delivery containers 111a, 111b, 111c from the conveying device 101 according to an order data L. The packing stations 11, 13, 15 receive the plurality of delivery containers 111a, 111b, 111c selected by the control device C from the conveying device 101. The order data L includes various types of information of an order of goods in the logistics warehousing system 1, such as orderer information, type of goods, sizes of goods and/or quantity of goods, etc.

In one embodiment of the present invention, the control device C further includes an order size calculation unit A. The order size calculation unit A is capable of calculating an order size data (not shown in the figures) according to a type of goods, sizes of goods and/or a quantity of goods included in the order data L. The order size data include data information of the most suitable (for example “minimum”) space required for placing goods of the order. The control device C is capable of selecting one of the plurality of delivery containers 111a, 111b, 111c from the conveying device 101 according to the order size data. In one embodiment of the present invention, the order size calculation unit A includes an artificial intelligence (AI) arithmetic unit. For example, the order size calculation unit A uses the artificial intelligence arithmetic unit to calculate the order size data according to a type of goods, sizes of goods, and/or a quantity of goods in the order data L.

In detail, the plurality of delivery containers 111a, 111b, 111c have accommodating spaces (not shown in the figures) with the same or different sizes. The control device C selects one of the plurality of delivery containers 111a, 111b, 111c with an accommodating space of specific sizes according to the order data L to provide the most suitable accommodating space for placing goods included in the order.

Specifically, the control device C is implemented by a processor, related electronic components, and/or related circuits (not shown in the figures).

In this embodiment, the personnel M1, M2, M3 of the packing stations 11, 13, 15 are capable of obtaining the plurality of delivery containers 111a, 111b, 111c selected by the control device C from the conveying device 101. The present invention does not limit the manner in which the control device C informs the personnel M1, M2, M3 about selecting the delivery containers 111a, 111b, 111c. In this embodiment, the packing stations 11, 13, 15 can include, for example, prompting devices C1, C2, C3 respectively. The control device C is capable of prompting the personnel M1, M2, M3 to obtain the delivery containers 111a, 111b, 111c which are selected through the prompting devices C1, C2, C3. The prompting devices C1, C2, and C3 are implemented by devices such as speakers, lights, and/or displays to provide prompting messages such as sound, texts, and/or graphics, but the present invention is not limited thereto.

In this embodiment, the logistics warehousing system 1 further includes a receiving device 103, a delivery device 105, and a recovery device 107. The receiving device 103 is disposed to place and move collecting containers 113a, 113b, 113c. The collecting containers 113a, 113b, 113c are, for example, containers for placing goods in logistics pick up operations. In this embodiment, the control device C selects one of the collecting containers 113a, 113b, 113c from the receiving device 103 according to the order data L, wherein at least one goods is placed in the collecting container which is selected. The control device C also selects one of the plurality of delivery containers 111a, 111b, 111c from the conveying device 101 according to the order data L, wherein the packing stations 11, 13, 15 receive the delivery container selected by the control device C from the conveying device 101.

As shown in FIG. 3, the control device C selects the collecting container 113a from the receiving device 103 according to the order data L, and at least one goods 115a is placed in the collecting container 113a which is selected. In this embodiment, the collecting container 113a is sent to the packing station 11. The control device C selects the delivery container 111a from the conveying device 101 according to the order data L, and the packing station 11 receives the selected delivery container 111a from the conveying device 101. Thereby, through the control device C and the order data L, the packing station 11 is capable of receiving the delivery container 111a appropriately, so that, the at least one goods 115a is placed into the delivery container 111a by, for example, the person M1 to achieve an object of packing. The manner in which the collecting container 113a being sent from the receiving device 103 to the packing station 11 is realized, for example, manually or by automated mechanism, and the present invention is not limited thereto.

Similarly, through control of the control device C, the packing stations 13, 15 respectively receive the collecting containers 113b, 113c selected by the control device C, and at least one goods 115b, 115c are respectively placed in the collecting containers 113b, 113c. The packing stations 13 and 15 respectively receive the delivery containers 111b and 111c selected by the control device C from the conveying device 101, and the details are not repeated here.

In addition, after the packing stations 11, 13, 15 respectively placing the at least one goods 115a, 115b, 115c into the plurality of delivery containers 111a, 111b, 111c, the packing stations 11, 13, 15 move the plurality of delivery containers 111a, 111b, 111c onto the delivery device 105 to be delivered. The delivery device 105 includes a conveyor belt (not shown in the figures) to move the plurality of delivery containers 111a, 111b, 111c to a sealing place or a delivery place (not shown in the figures). In one embodiment of the present invention, the delivery device 105 is connected to a sealing device and/or a labeling device (not shown in the figures) to seal and/or label the plurality of delivery containers 111a, 111b, 111c. The packing stations 11, 13, 15 move the collecting containers 113a, 113b, 113c onto the recovery device 107 to recover the collecting containers 113a, 113b, 113c for performing subsequent operations of the logistics warehousing system 1. The recovery device 107 includes a conveyor belt (not shown in the figures) to perform the recovery operation aforementioned. Methods of the packing stations 11, 13, 15 moving the plurality of delivery containers 111a, 111b, 111c onto the delivery device 105, and moving the collecting containers 113a, 113b, 113c onto the recovery device 107 are implemented manually or by automatic mechanism, and the present invention is not limited thereto.

In FIG. 1 and FIG. 3, relative positional relationships between the receiving device 103, the delivery device 105, the recovery device 107, and the conveying device 101 are merely an illustration, and are not intended to limit the present invention. In FIG. 1, the receiving device 103, the delivery device 105 and the recovery device 107 are disposed on the central area 101c, such that, a space of the logistics warehousing system 1 is further saved, and an operation efficiency of the logistics warehousing system 1 is enhanced. In FIG. 3, the receiving device 103, the delivery device 105 and the recovery device 107 are disposed on one side of the conveying device 101, such that, disposition and/or operation of the logistics warehousing system 1 is changed to be more diversified in applications.

In this embodiment, the logistics warehousing system 1 further includes a container supply device 109. The container supply device 109 provides the plurality of delivery containers 111a, 111b, 111c, and places the delivery containers 111a, 111b, 111c on the conveying device 101. For example, the container supply device 109 is capable of placing the delivery containers 111a, 111b, 111c on the conveying device 101 in a preset sequence (not shown in the figures), and the preset sequence includes parameters such as types, accommodating spaces, sizes, quantities, and/or disposition distances of the plurality of delivery containers 111a, 111b, 111c. In one embodiment of the present invention, the preset sequence is calculated by the control device C according to the order data L (including type of goods, sizes of goods and/or quantity of goods, etc.) to optimize a packing efficiency of the logistics warehousing system 1. The control device C is also capable of controlling a moving speed of the circular conveyor 1011 of the conveying device 101 to optimize the packing efficiency of the logistics warehousing system 1. In one embodiment of the present invention, the preset sequence and the moving speed of the circular conveyor 1011 are calculated by the control device C according to the order data L through the artificial intelligence arithmetic unit of the order size calculation unit A. In one embodiment of the present invention, the artificial intelligence arithmetic unit includes a chaos theory arithmetic device, and the preset sequence and the moving speed of the circular conveyor 1011 is calculated by the control device C according to the order data L through the chaos theory arithmetic device.

In addition, the control device C is capable of continuously adjusting the aforementioned parameters such as the preset sequence and/or the moving speed of the circular conveyor 1011 to optimize the packing efficiency.

The container supply device 109 further includes a box opener (not shown in the figures). The box opener is capable of opening the plurality of delivery containers 111a, 111b, 111c to expose the accommodating spaces thereof before placing the delivery containers 111a, 111b, 111c on the conveying device 101 to facilitate operations of the packing stations 11, 13, 15 and greatly improve the packing efficiency of the logistics warehousing system 1.

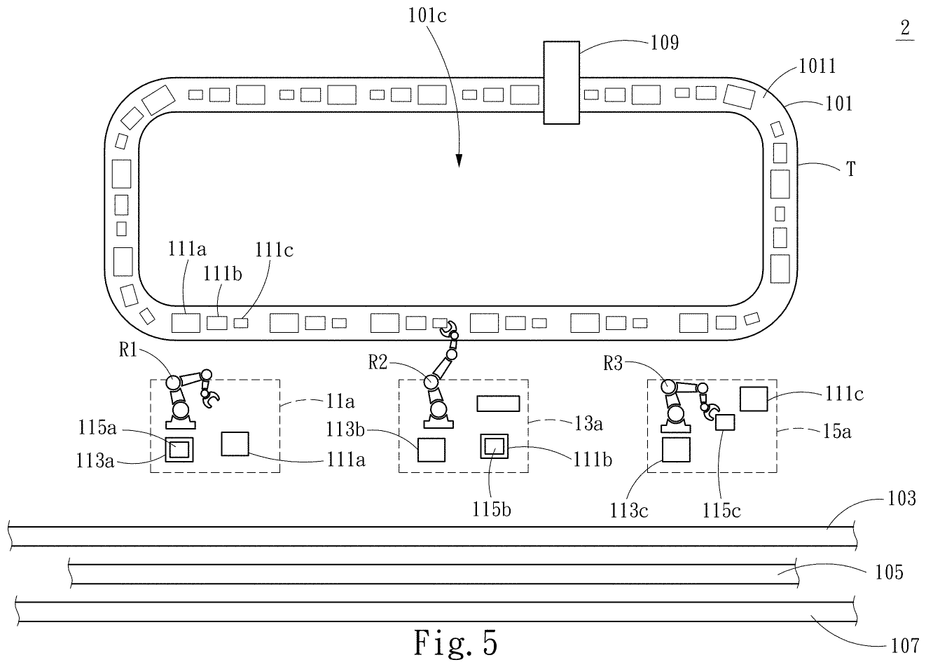

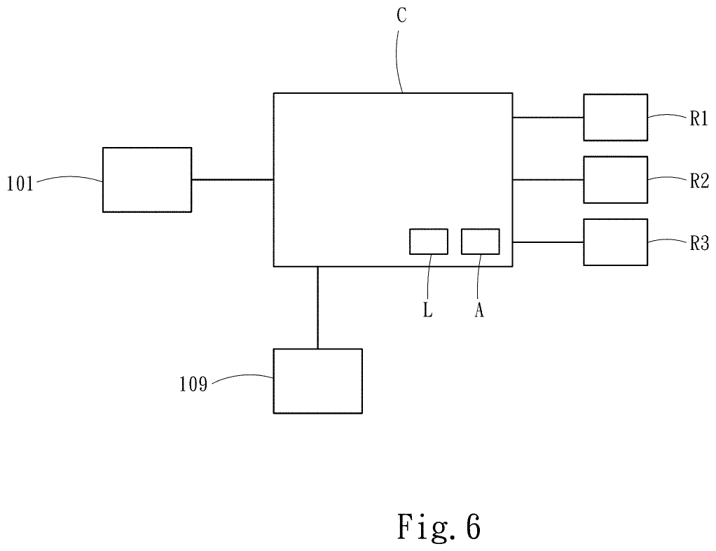

Please refer to FIGS. 5 and 6. FIG. 5 is a schematic diagram of a logistics warehousing system 2 according to another embodiment of the present invention. FIG. 6 is a functional block diagram of the logistics warehousing system 2 of the embodiment shown in FIG. 5. The logistics warehousing system 2 of this embodiment has structures and functions similar to that of the logistics warehousing system 1 shown in FIGS. 3 and 4. The difference between this embodiment and the embodiment shown in FIGS. 3 and 4 is that: the logistics warehousing system 2 of this embodiment includes packing stations 11a, 13a, 15a. The packing stations 11a, 13a, 15a include picking devices R1, R2, R3, respectively. The picking devices R1, R2, R3 receive the plurality of delivery containers 111a, 111b, 111c selected by the control device C, and the picking devices R1, R2, R3 respectively place at least one goods into accommodating spaces of the delivery containers selected by the control device C.

As shown in FIG. 5, the control device C selects the collecting container 113a from the receiving device 103 according to the order data L, and the at least one goods 115a is placed in the collecting container 113a which is selected. In this embodiment, the collecting container 113a is sent to the packing station 11a. The control device C selects the delivery container 111a from the conveying device 101 according to the order data L, and the picking device R1 of the packing station 11a receives the delivery container 111a selected by the control device C. Thereby, the packing station 11a is capable of receiving the delivery container 111a appropriately, so that the picking device R1 is capable of placing the at least one goods 115a into the accommodating space (not shown in the figures) of the delivery container 111a to achieve an object of automatic packing. In addition, the manner in which the collecting container 113a being sent to the packing station 11a is also operated, for example, by the picking device R1, and the present invention is not limited thereto.

Similarly, through the control of the control device C, the packing stations 13a, 15a respectively receive the collecting containers 113b, 113c selected by the control device C, and the at least one goods 115b, 115c are respectively placed in the collecting containers 113b, 113c. The picking devices R2, R3 of the packing stations 13a, 15a receive the delivery containers 111b, 111c selected by the control device C, and the details are not repeated here.

In this embodiment, the picking devices R1, R2, R3 are implemented by automated mechanical arms, but the present invention is not limited thereto. The picking devices R1, R2, R3 can be implemented by any possible mechanical mechanisms.

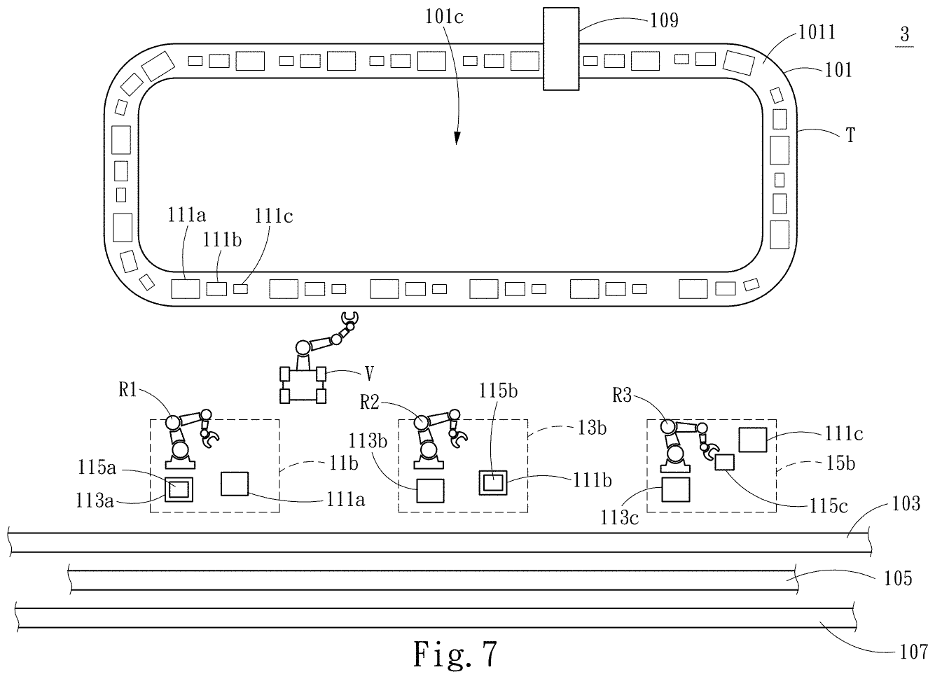

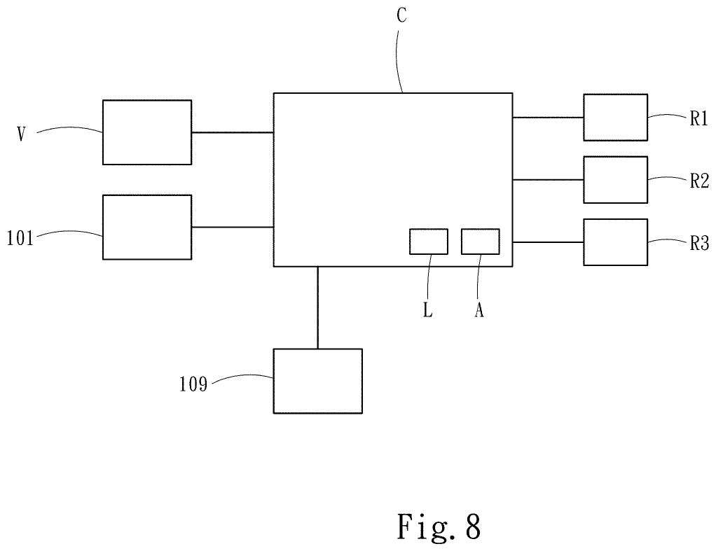

Please refer to FIGS. 7 and 8. FIG. 7 is a schematic diagram of a logistics warehousing system 3 according to another embodiment of the present invention. FIG. 8 is a functional block diagram of the logistics warehousing system 3 of the embodiment shown in FIG. 7. The logistics warehousing system 3 of this embodiment has structures and functions similar to that of the logistics warehousing system 2 shown in FIGS. 5 and 6. The difference between this embodiment and the embodiment shown in FIGS. 5 and 6 is that the logistics warehousing system 3 of this embodiment includes a transport device V, and packing stations 11b, 13b, 15b. The transport device V moves the delivery container selected by the control device C to one of the packing stations 11b, 13b, 15b according to the order data L.

As shown in FIG. 7, the control device C selects the collecting container 113a from the receiving device 103 according to the order data L, and the at least one goods 115a is placed in the collecting container 113a which is selected. In this embodiment, the collecting container 113a is sent to the packing station 11b. The control device C selects the delivery container 111a from the conveying device 101 according to the order data L, and the transport device V moves the delivery container 111a selected by the control device C to the packing station 11b according to the order data L. The picking device R1 of the packing station 11b receives the delivery container 111a from the transport device V. Thereby, the packing station 11b is capable of receiving the appropriate delivery container 111a to achieve an object of automatic packing.

Similarly, the picking devices R2, R3 of the packing stations 13b, 15b are capable of receiving the delivery containers 111b, 111c selected by the control device C from the transport device V, and the details are not repeated here. Through the transport device V, disposition and/or operation of the logistics warehousing system 1 can be changed to be more diversified in applications.

In other embodiments of the present invention, the logistics warehousing system is implemented without the picking devices R1, R2, R3, but is implemented with the personnel M1, M2, M3 shown in FIG. 3. That is, through the personnel M1, M2, M3, the packing stations 11b, 13b, 15b are capable of receiving the delivery containers 111a, 111b, 111c delivered by the transport device V, and the details are fully taught by referring to the embodiment shown in FIGS. 3 and 4, which will not be repeated here.

In this embodiment, the transport device V is implemented by an automated guided vehicle (AGV), but the present invention is not limited thereto. The transport device V can be implemented by any possible mechanical mechanisms.

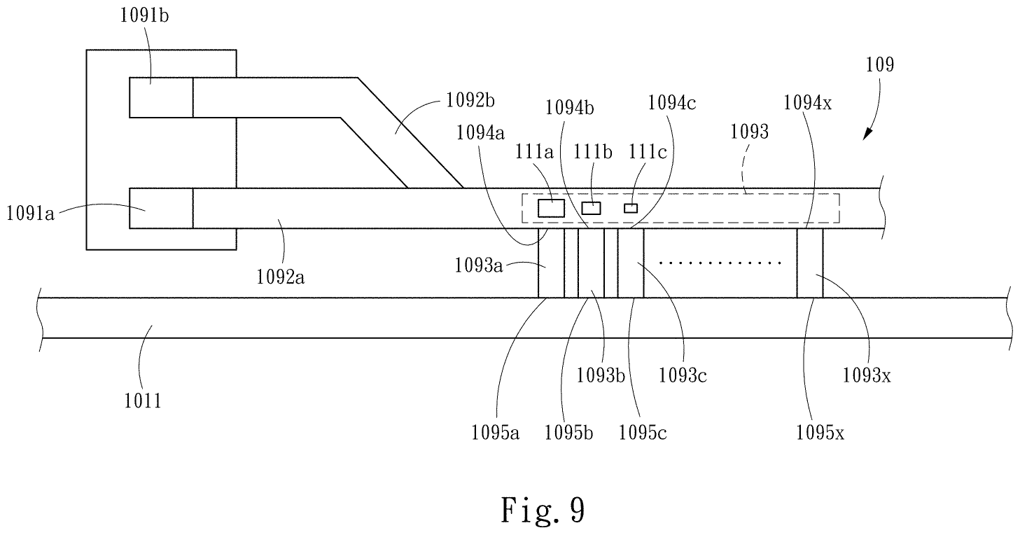

Please refer to FIG. 9, which is a schematic diagram of a possible implementation manner of the container supply device 109 of the logistics warehousing system 1 shown in FIG. 1. The container supply device 109 includes box openers 1091a, 1091b and a temporary storage area 1093. The box openers 1091a, 1091b are capable of converting the plurality of delivery containers 111a, 111b, 111c from a storage state to an accommodating state, for example, assembling a carton from a flat plate shape that is easy to store into a box shape with an opening. The temporary storage area 1093 is capable of temporarily storing the delivery containers 111a, 111b, 111c which are opened, so that the container supply device 109 is capable of placing the delivery containers 111a, 111b, 111c on the circular conveyor 1011 in the preset sequence.

Specifically, the box openers 1091a, 1091b are capable of transferring the plurality of delivery containers 111a, 111b, 111c to the temporary storage area 1093 through conveyor belts 1092a, 1092b, respectively. The temporary storage area 1093 is capable of placing the plurality of delivery containers 111a, 111b, 111c on the circular conveyor 1011 in the preset sequence through a plurality of conveyor belts 1093a, 1093b, 1093c, 1093x. The conveyor belts 1093a, 1093b, 1093c, 1093x respectively have receiving ends 1094a, 1094b, 1094c, 1094x connected to the container supply device 109, and output ends 1095a, 1095b, 1095c, 1095x connected to the circular conveyor 1011. Through the temporary storage area 1093 and the conveyor belts 1093a, 1093b, 1093c, 1093x, the packing efficiency of the logistics warehousing system 1 is optimized.

The container supply device 109 shown in FIG. 9 is illustrated with the two box openers 1091a, 1091b, but the present invention does not limit a quantity or type of the box opener. The container supply device 109 shown in FIG. 9 is illustrated with the four conveyor belts 1093a, 1093b, 1093c, 1093x, but the present invention does not limit a quantity of the conveyor belt. A quantity of the conveyor belt capable of letting the temporary storage area 1093 to place the delivery containers 111a, 111b, 111c on the circular conveyor 1011 in the preset sequence is within the scope of the present invention.

In addition, the box openers 1091a, 1091b, for example, correspond to the plurality of delivery containers of different sizes/volumes. For example, the box opener 1091a is capable of opening and providing a delivery container with sizes of the delivery container 111a, and the box opener 1091b is capable of opening and providing a delivery container with sizes of the delivery container 111b. By disposing the box openers 1091a, 1091b corresponding to the delivery containers 111a, 111b of different sizes/volumes, the packing efficiency of the logistics warehousing system 1 is optimized.

Incidentally, the plurality of delivery containers 111a, 111b, 111c could be flat cardboards before being opened. The box openers 1091a, 1091b are capable of assembling the plurality of delivery containers 111a, 111b, 111c from a flat cardboard state into a carton state, and the accommodating spaces of the plurality of delivery containers 111a, 111b, 111c are exposed.

Practically, specifications and/or sizes of the delivery container are determined according to the content of the order. Considering that the content of the order that has not been received is unknown, it is difficult to predict or determine in advance what type of the delivery container is required. In traditional logistics applications, the different delivery containers are statically placed in a storage space and occupy a large space, and the operator moves and gets the delivery container only after receiving or confirming the content of the order, resulting in waste of time. In contrast, in the present invention, the different delivery containers are dynamically circulated, so that the storage space for the delivery containers is reduced, and the packing stations are capable of efficiently, automatically and quickly obtaining the delivery containers of different specifications and/or sizes, and then completing the packing operation according to the order.

In summary, the logistics warehousing system of the present invention allows the packing stations to receive the correct delivery containers from the conveying device effectively, accurately and quickly by the conveying device arranged with the circular conveyor, thereby capable of greatly improving the efficiency of the logistics warehousing system and effectively using the warehousing space.

Note that the specification relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A logistics warehousing system comprising:
a conveying device, comprising a circular conveyor surrounding a central area, the circular conveyor circulating cyclically relative to the central area;
a plurality of delivery containers, comprising at least one first delivery container and at least one second delivery container different from the at least one first delivery container, the plurality of delivery containers placed on the circular conveyor and circulating along a circular track around the center area cyclically as the circular conveyor circulating; and
at least one packing station, one of the at least one packing stations receiving one of the plurality of delivery containers from the conveying device.

2. The logistics warehousing system as claimed in claim 1, wherein the logistics warehousing system comprises a control device, the control device selects one delivery container with a specific size from the conveying device according to an order data, and wherein the packing station receives the delivery container which is selected from the conveying device.

3. The logistics warehousing system as claimed in claim 2, wherein each of the at least one packing station includes a picking device, one of the picking devices receives the delivery container selected by the control device, and one of the picking devices places at least one goods into an accommodating space of the delivery container.

4. The logistics warehousing system as claimed in claim 3, wherein the logistics warehousing system further comprises a receiving device disposed to place and move at least one collecting container, and the control device selects one of the at least one collecting container from the receiving device according to the order data, and the at least one goods is placed in the collecting container which is selected.

5. The logistics warehousing system as claimed in claim 3, wherein the logistics warehousing system further comprises a delivery device, and the picking device moves the delivery container placed with the at least one goods onto the delivery device.

6. The logistics warehousing system as claimed in claim 2, wherein the logistics warehousing system further comprises a transport device, the transport device moves the delivery container selected by the control device to one of the at least one packing station according to the order data, wherein each of the packing stations comprises a picking device, and the picking device is disposed to place at least one goods into an accommodating space of the delivery container which is received by the picking device.

7. The logistics warehousing system as claimed in claim 6, wherein the logistics warehousing system further comprises a receiving device disposed to place and move at least one collecting container, the control device selects one of the at least one collecting container from the receiving device according to the order data, and the at least one goods is placed in the collecting container which is selected.

8. The logistics warehousing system as claimed in claim 6, wherein the logistics warehousing system further comprises a recovery device, and after the picking device placing the at least one goods into the delivery container, the picking device moves the collecting container onto the recovery device.

9. The logistics warehousing system as claimed in claim 6, wherein the logistics warehousing system further includes a delivery device, and the picking device moves the delivery container placed with the at least one goods onto the delivery device.

10. The logistics warehousing system as claimed in claim 1, wherein the logistics warehousing system further comprises a control device, a receiving device, a delivery device, and a recovery device, the receiving device is disposed to place and move at least one collecting container, the control device selects one of the at least one collecting container from the receiving device according to an order data, at least one goods is placed in the collecting container which is selected, the control device selects one of the plurality of delivery containers from the conveying device according to the order data, and wherein the packing station receives the delivery container which is selected from the conveying device, and after the packing station places the at least one goods into the delivery container, the packing station moves the delivery container onto the delivery device and moves the collecting container onto the recovery device.

11. The logistics warehousing system as claimed in claim 1, wherein the logistics warehousing system further comprises a container supply device, the container supply device comprises a box opener that converting the plurality of delivery containers from a storage state to an accommodating state, and a temporary storage area connected to the box opener, the temporary storage area comprises a plurality of conveyor belts respectively corresponding to the first delivery container and the second delivery container, and each of the plurality of conveyor belts having a receiving end connected to the box opener and an output end connected to the circular conveyor.

12. A logistics warehousing system comprising:
a conveying device, comprising an circular conveyor surrounding a central area, the circular conveyor circulating cyclically relative to the central area;
a plurality of delivery containers, comprising at least one first delivery container and at least one second delivery container different from the at least one first delivery container, the plurality of delivery containers placed on the circular conveyor and circulating along a circular track around the center area cyclically as the circular conveyor circulating;
at least one packing station, one of the at least one packing station receiving one of the plurality of delivery containers from the conveying device;
a receiving device, disposed to place and move at least one collecting container, at least one goods placed in the collecting container;
a delivery device; and
a recovery device, wherein the packing station receives one of the at least one collecting container from the receiving device, after the packing station places the at least one goods into the delivery container received, the packing station moves the delivery container onto the delivery device and moves the collecting container onto the recovery device.
